(19) United States
(12) Patent Application Publication
(10) Pub. No.: US 2011/0113696 A1
(43) Pub. Date: May 19, 2011

(54) DRAFT BLOCKER ASSEMBLY FOR LIFTING A DRAFT BLOCKER AND METHOD

(76) Inventor: Gerald B. Gallagher, Acton, MA (US)

(21) Appl. No.: 12/621,637

(22) Filed: Nov. 19, 2009

(51) Int. Cl. E06B 7/18; E06B 7/16

(52) U.S. Cl. 49/493.1; 49/475.1

(57) ABSTRACT

A draft blocking apparatus for a door is described. A hinge for attachment to a door is described. A rotating assembly attached to the door permits the rotating assembly to rotate about the hinges, and to rotate relative to the door, the rotating assembly arranged to accommodate a draft blocker. A mechanism to convert motion of the door as the door is closed into motion to lower the draft blocker into a position to contact a floor by rotation about the hinges, in order to block a draft which would otherwise pass under the door when the door is in a closed position.

### FIELD OF THE INVENTION

This invention relates to the field of “draft blockers”, “door sweeps” and other insulating arrangements including, for example, cloth cylinders, fins, strips or other insulating material, near the bottom of a door to provide insulation against wind or draft coming under the closed door.

### BACKGROUND OF THE INVENTION

Many exterior doors on a building, for example a residential house, have on the bottom of the doors what are known as “sweeps” to provide protection against moisture such as rain, snow, or ice penetrating under the door. Such sweeps also provide a measure of insulation against either heat escaping under the door or cold wind blowing under the door. The cold wind blowing under the door may arise from weather conditions such as a cold windy day, blizzard conditions, or other causes. The sweeps are often made of neoprene, polychloroprene, synthetic rubber, vinyl, nylon, etc., hereinafter all of which are referred to as a “rubber strip”. Such rubber strips are made of materials which may not provide adequate protection or insulation against heat or cold. When the door is closed, the rubber strip is, preferably, in constant contact with the floor or a threshold when present. Because such sweeps move with the door's movement, there are limitations on their size, form of array and posture.

Door sweeps are usually attached to the horizontal bottom of the door, and as such they are not easily accessible and present a difficulty in repair and replacement. Also, they are subject to friction, and friction causes wear whenever the door is in motion, as in being opened or closed. The friction wears down the rubber strip so that wind can pass between the rubber strip and the door frame, thereby rendering the sweep ineffective.

Generally speaking, door sweeps are usually designed to be in a fixed, permanent position under the door, or on the exterior bottom of the door, and they are required to be in a horizontal position no longer than the width of the door. Because a door is opened and closed from time to time, and moves in an arc in opening and closing, there arises a need that the sweep have a minor gap at each end to accommodate the motions and to fit within the door frame. A door sweep placed under the horizontal edge of the door cannot be longer than the width of the door. Thus, a sweep of common design must have gaps at its ends, and heat can escape and cold air can enter past the door because of the gaps. Additionally, wear from motion of the door can result in gaps at the bottom of a door sweep, and at the ends of a door sweep.

A “draft blocker”, or “draft suppressor”, or “draft stopper”, or “draft guard” (herein referred to as a “draft blocker”) is formed by insulation which, in an embodiment of the invention, is longer than the width of a door, and may be placed against the bottom of the door on the inside. For example, a small rug may serve as a draft blocker. Also a cylindrical cloth material having an insulating stuffing may be used as a draft blocker. Such “draft blockers” are frequently decorative and are made so as to be put in place by hand when the door is in a closed position. Hand placement sometimes results in mis-placement of the draft blocker. Also, to open the door, they must be manually removed. In order to be effective, they have to be returned to their proper place by hand or foot. Also, they frequently interfere with the opening movement of a door when the door is opened from outside, where the draft blocker is not located, and from which direction a person who is entering the building arrives.

It is desirable to have an apparatus which can block the movement of air under a door, including blocking the transfer of heat or cold under the door, and that does not have the problems of existing door sweeps and draft blockers.

### SUMMARY OF THE INVENTION

The invention is a draft blocker assembly which is hinged to lower and rise along a line parallel to the bottom of a door and a short distance above the bottom of the door, and is actuated by a spring or springs to rotate about the hinge as the door is opened and closed. As the door is opened the draft blocker is rotated upward by the spring or springs, and as the door is closed the draft blocker is lowered by mechanical action of an actuating mechanism. The draft blocker remains a short distance above the floor and so has no friction against the floor as the door is opened and closed. After the door is closed, the draft blocker is in contact with the door and the floor to block drafts. As the door is closed, the draft blocker cooperates with the actuating mechanism which interacts with the draft blocker to move the draft blocker into a position where it blocks the motion of air, heat, and cold under the door.

Alternatively, springs may be arranged to bring the draft blocker into contact with the floor and the door, that is into draft blocking position, by the springs, and then be lifted by an actuating mechanism.

The springs may be manufactured in the hinge as a spring actuated hinge. Alternatively, the spring may be a linear spring which applies force between the rotating mechanism and the door in order to lift the draft blocker into the raised position as the door is opened. As a further alternative, the spring may be of any arrangement which aids in raising the draft blocker as the door is opened.

Alternatively, the actuating mechanism, may be for example, a post mounted on a wall and near the bottom of the door, and the actuating mechanism operates with a lever attached to the draft blocker. The post may have a rotating wheel to reduce friction when interacting with the lever attached to the draft blocker. The post presses against the lever as the door is closed, to cause the draft blocker to rotate about its hinge and go from a raised position into a lowered position. In the lowered position the draft blocker blocks drafts which would otherwise pass under the door, and so provides insulation against heat or cold from passing past the door.

Also, alternatively, the actuating mechanism may be, for example, a rotatable wheel mounted with the draft blocker, with the wheel mounted so that as the door is closed the wheel contacts a fixed portion of the door frame. The wheel then applies a torque to the draft blocker, causing the draft blocker to rotate about the hinges and against the pull of the spring. The draft blocker then goes from a raised position where it is held by the spring, to a lowered position as the wheel causes the draft blocker to move into a lowered position.

As a further alternative, the mechanism may be any combination of levers, wheels, and other mechanical elements which cooperate to raise the draft blocker as the door is opened, and which cooperate to move the draft blocker into contact with the door and floor as the door is closed.

The inventive rotating draft blocker assembly may be used with a draft blocker made of soft material, for example, a cloth cylinder of known design.

The inventive draft blocker assembly may be used, for example, with draft blockers of known existing design, as discussed herein above. Such draft blockers may be attached to a rotating mechanism of the inventive draft blocker assembly. The draft blocker is moved into draft blocking position as the door is closed, by the rotation of the draft blocker assembly, for example, about a set of hinges.

Also, the draft blocker assembly may be used with a door sweep of previous design, such as an insulating strip, for example a rubber strip, attached to the bottom of the door. The insulating strip may be arranged so that it does not interfere with rotation of the inventive draft blocker assembly.

The inventive draft blocker assembly may also be slightly longer than the door is wide, and so fit tightly against the door frame on both sides of the vertical edges of the door, so as to further block drafts from both passing under and around the door.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

The invention description below refers to the accompanying drawings, of which:

FIG. 1A is an isometric front view from the inside side of the door in open position;

FIG. 1B is an isometric drawing of a support board.

FIG. 1C is an isometric view of a draft blocker.

FIG. 1D is a cross section of a draft blocker and support board.

FIG. 1E is a front view of a rotating board.

FIG. 1F is a cross section of a draft blocker.

FIG. 1G is a cross section of a draft blocker.

FIG. 2 is a front view from the inside side of the door in closed position;

FIG. 3A is a view along Section A-A as shown in FIG. 2;

FIG. 3B is an enlarged view of a post supporting a wheel and interacting with a pressure plate.

FIG. 4A is an isometric front view of draft blocker using a movable rotatable wheel mechanism with the door in open position.

FIG. 4B is a cross section of a part of FIG. 4A showing a stop mechanism.

FIG. 4C is a cross section of a part of FIG. 4A showing a protector plate.

FIG. 4D is a cross section of a part of FIG. 4A showing a spring plate.

FIG. 5 is an isometric front view of draft blocker using a movable rotatable wheel mechanism with the door in closed position.

FIG. 6 is a left side view from the front of a rotatable draft blocker mechanism with the door in closed position . . . .

FIG. 7 is an isometric rear view from an end of a rotatable draft blocker mechanism, with the side of the rotatable mechanism adjacent to a door illustrated.

FIG. 8 is an isometric end view of a draft blocker mechanism showing an attachment of a wheel.

FIG. 9 is an isometric rear view of a rotatable draft blocker mechanism.

FIG. 10A is an isometric front view of a face plate attached to a door.

FIG. 10B is a rear view of a faceplate with attachment brackets.

FIG. 10C is a mounting board.

FIG. 10D is a rotating board.

FIG. 10E is a draft blocker with an attached shield.

FIG. 10F is an isometric view of a draft blocker with an attached shield.

FIG. 10G is an end view of a draft blocker with a shield.

FIG. 11A-FIG. 11D show a bracket used to hold a mounting board to a door or faceplate.

FIG. 11E-FIG. 11F show a bracket removably holding a mounting board to a door or faceplate.

FIG. 12 is a rear view of a closed door having a one size fits all draft blocking movable shield.

FIG. 13 is a cross sectional view of sliding brackets to mount a draft blocking movable shield.

FIG. 14A, FIG. 14B, FIG. 15A, FIG. 15B, FIG. 16, FIG. 17, and FIG. 18 show various spring actuated hinges.

FIG. 19 is an end view showing a door frame and a draft blocker assembly in cross section.

FIG. 20A is an isometric view of a draft blocker.

FIG. 20B is a cross section at Section B-B′ of FIG. 20A, and including a rotating board.

FIG. 21A cross section view of a draft blocker and a rotating board.

FIG. 21B is a cross section view showing a draft blocker attached to a support board.

FIG. 21C is a cross section view showing a draft blocker attached to a support board.

FIG. 22 is a top view of a draft blocker as used with a door mounted with an alcove.

### DETAILED DESCRIPTION

### First Exemplary Embodiment

Definitions:

A “draft blocker” as used herein is a flexible cylindrical structure which is used by placing it against the bottom of a door to block drafts from blowing under the door and otherwise provide thermal insulation between cold conditions on a first side of the door and warm conditions on a second side of the door. Traditionally, a draft blocker is placed by hand against the bottom edge of a closed door.

A “lifting mechanism for a draft blocker” is a mechanical mechanism used to lift a draft blocker by action of movement of a door, and is more fully described herein. A draft blocker and the lifting mechanism are referred to herein as a “draft blocker assembly”.

A “door sweep” is a term often used to describe a rubber type of material attached to an edge of a door, such as the bottom of the door, to help prevent wind and moisture from passing under the door.

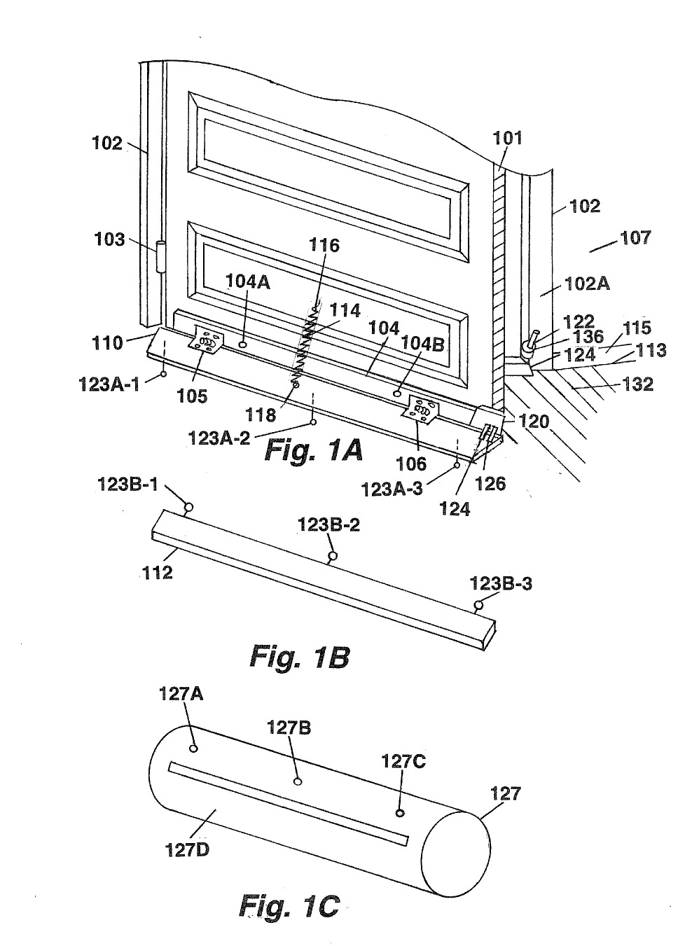

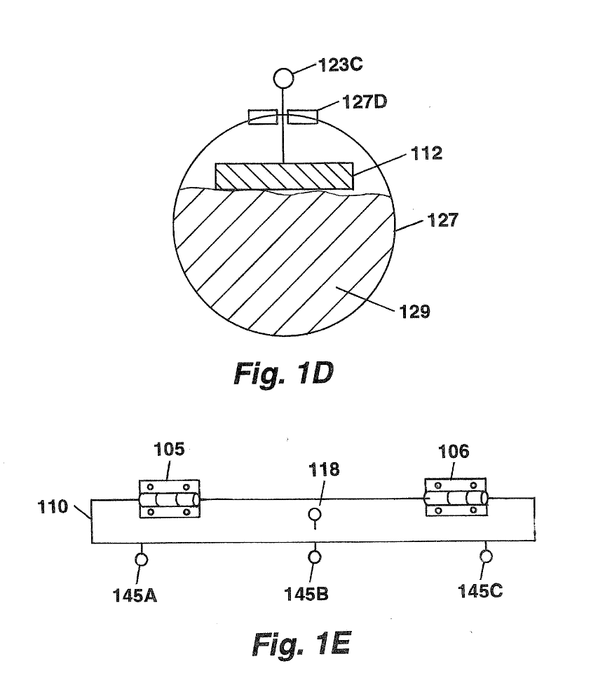

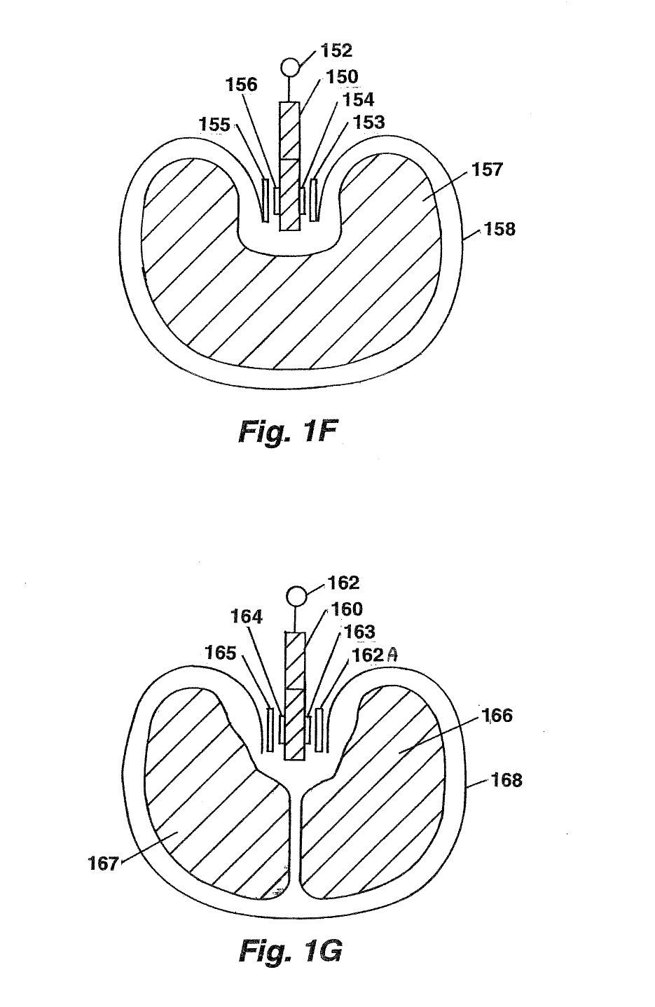

Referring now to FIG. 1A, door 101 is shown mounted in door frame 102, and is attached to door frame 102 by hinges 103. Mounting board 104 is attached to door 101, for example, by screws 104a and 104b. Hinge 105 and hinge 106 are attached to mounting board 104 and, in turn, are attached to rotating board 110.

Turning now to FIG. 1B and FIG. 1C, and FIG. 1D, draft blocker 127 is attached to rotating board 110. The attachment of draft blocker 127 to rotating board 110 is by attachment devices 123A-1, 123A-2 and 123A-3, which interlock with attachment device 123B-1, 123B-2 and 123B-3, respectively.

Attachment devices 123A-1, 123A-2 and 123A-3 are fixedly attached to rotating board 110. Attachment devices 123B-1, 123B-2 and 123B-3 are fixedly attached into support board 112.

Turning now to FIG. 1C, draft blocker 127 has opening 127A for attachment device 123B-1 to pass through. Draft blocker 127 has hole 127B for attachment device 123B-2 to pass through. Draft blocker 127 has hole 127C for attachment device 123B-3 to pass through.

Turning now to FIG. 1D, draft blocker 127 is shown filled with insulating material 129. Support board 112 is inside draft blocker 127, and support device 123C passes through hole 127D, as shown in FIG. 1D.

Support device 123B-1 interlinks with support device 123A-1, as do also support device 123B-2 interlinks with support device 123A-2, and support device 123B-3 interlinks with support device 123A-3, to support draft blocker 127 from rotating board 110.

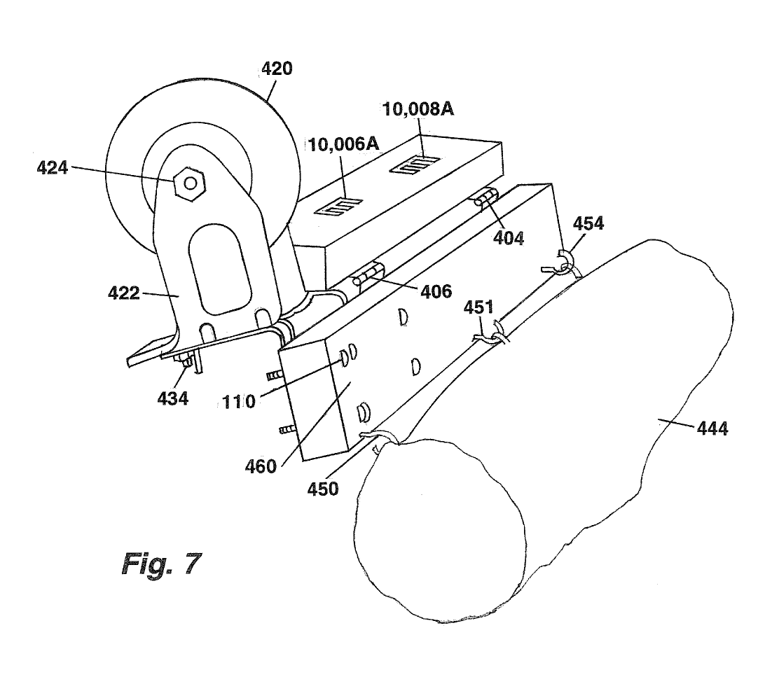

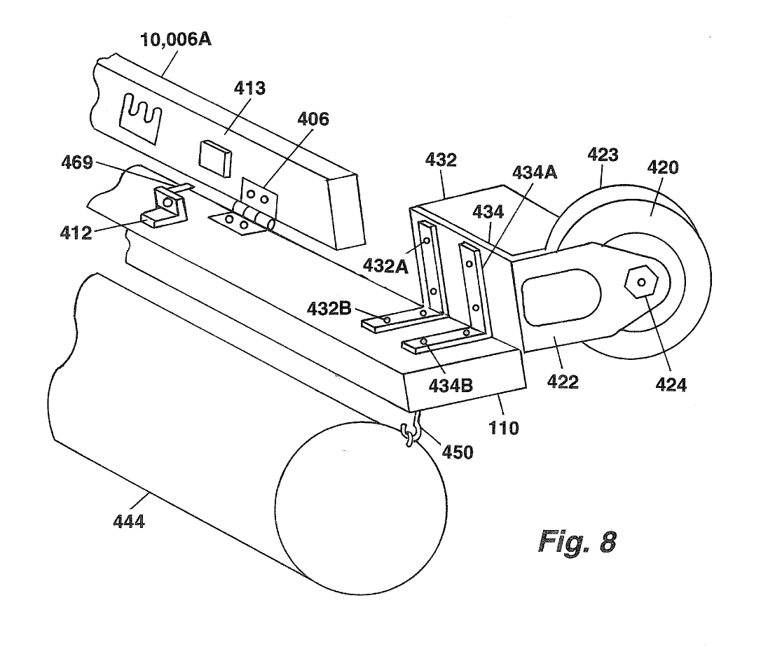

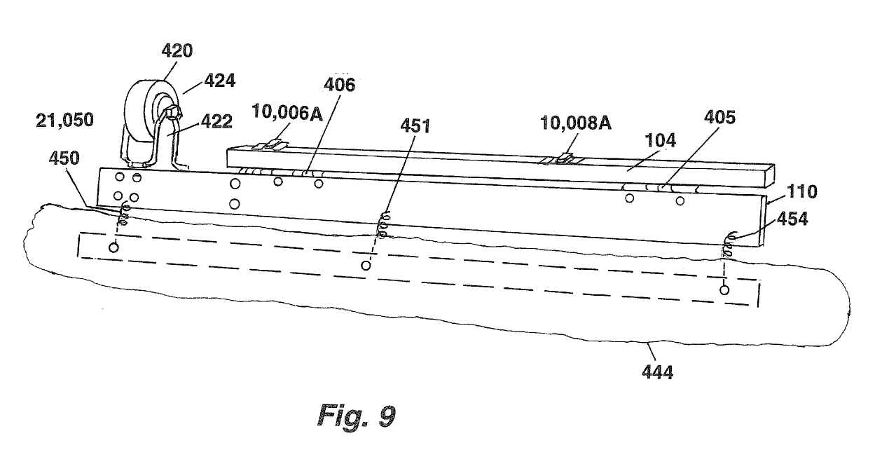

The support of draft blocker 127 by interlinked attachment devices is more clearly shown in FIG. 7, FIG. 8, FIG. 9 and other drawings.

Turning now to FIG. 1E, a detailed view of rotating board 110 is shown. Rotating board 110 is shown with hinge 105 and hinge 106 attached thereto. The other side of hinges 105 and 106 attach to mounting board 104, as shown in FIG. 1A. Attachment devices 145A, 145B and 145C illustrate an alternative fixed attachment of the attachment devices to rotating board 110, in that attachment devices 145A, 145B and 145C, for example, are screwed into an edge 110A of rotating board 110. In contrast, in FIG. 1A the attachment devices 123A-1, 123A-2 and 123A-3 are screwed into an underside of rotating board 110.

Turning now to FIG. 1F, a cross-section of alternative arrangement for mounting the draft blocker to rotating board 110 is illustrated. In FIG. 1F, the draft blocker 158 contains insulating material 157. A support board 150 has attachment device 152 which, illustratively, attach to attachment devices, for example, such as attachment devices 123A-1, 123A-2 and 123A-3 shown in FIG. 1B, or, for example, may attach to attachment devices as illustrated in FIG. 1E as attachment devices 145A, 145B and 145C. Further illustrated in FIG. 1F is Velcro strip 154 and matching Velcro strip 153. Also illustrated in FIG. 1F is Velcro strip 156 and matching Velcro strip 155. Attachment of draft blocker 158 to support board 150 is by an interlocking of Velcro strip 154 with Velcro strip 153 and interlocking of Velcro strip 156 with Velcro strip 155.

Turning now to FIG. 1G, draft blocker 168 is illustrated by having more than one batch of insulating material, such as batch of insulating material 166 and batch of insulating material 167. As illustrated in FIG. 1G, support board 160 is also attached by attachment devices 162 to corresponding attachment devices such as are illustrated in FIG. 1A as attachment devices 123A-1, 123A-2 and 123A-3. Draft blocker 168 is illustratively attached to Velcro strip 162, and Velcro strip 162 interlocks with Velcro strip 163, which is attached fixedly to support board 160. Also Velcro strip 164 is fixedly attached to support board 160, and interlocks with Velcro strip 165 which is attached to draft blocker 168.

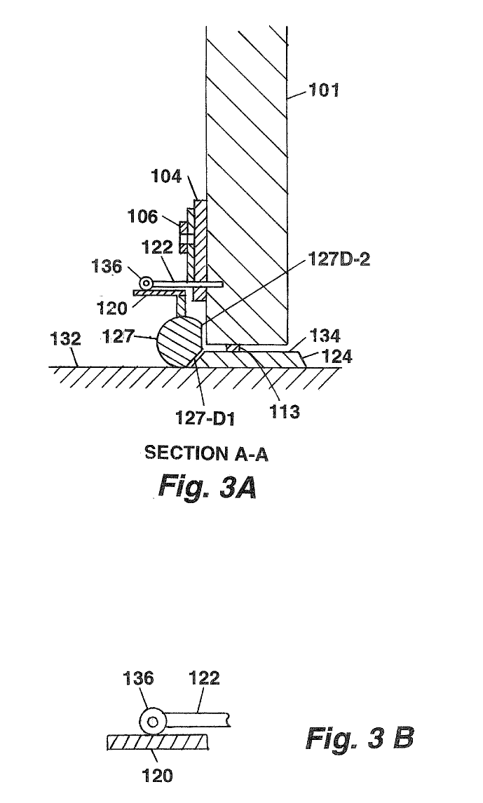

Thus, as illustrated in FIG. 1A-FIG. 1G, draft blocker 127 is movably attached to rotating board 110 through the attachment devices 123A-1, etc., interlocking with attachment devices 123B-1, etc. As rotating board 110 rotates upward about hinge 105 and hinge 106 rotating board 110 lifts draft blocker 127, and as rotating board 110 rotates downward about hinge 105 and hinge 106, rotating board 110 presses draft blocker 127 into contact with floor 132, threshold 124 and door 101, where draft blocker 127 blocks drafts which would otherwise pass under door 101, through space 134 as further illustrated in FIG. 3A.

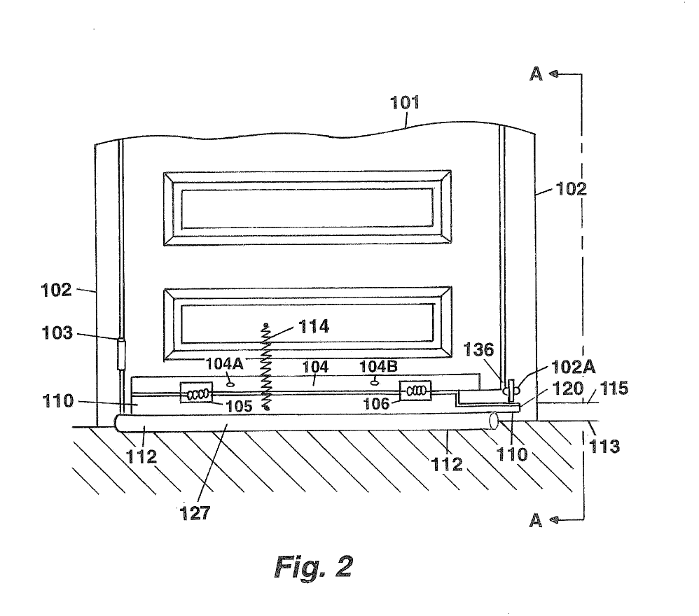

Mounting board 104, rotating board 110, and support board 112 are principal components of the inventive “lifting mechanism” for a draft blocker, in an illustrative embodiment of the invention shown in FIG. 1A, FIG. 1B, FIG. 1C, FIG. 1D, FIG. 2, FIG. 3A and FIG. 3B. Mounting board 104, rotating board 110 and support board, along with draft blocker 127 form an exemplary “draft blocker assembly”.

Returning to FIG. 1A, floor 132, is shown in a room into which door 101 opens. Baseboard 115 provides a decorative joint 113 between wall 107 and the floor 132.

In operation, rotating board 110 rotates about hinge 105 and hinge 106 to move from the position shown in FIG. 1A, which is substantially perpendicular to the plane of door 101, to a position illustrated in FIG. 2. In the position illustrated in FIG. 2, rotating board 110 is substantially in the plane of door 101, that is rotating board 110 is substantially parallel to door 101.

In operation, as door 101 is closed against door frame element 102A, pressure plate 120 comes in contact with wheel 136 mounted by post 122. Pressure plate 120 is attached by brackets 124 and 126 to rotating board 110.

Spring 114 is attached to door 101 at its first end 116 and is attached to rotating board 110 at its second end 118. Spring 114 pulls rotating board 110 up into the position shown in FIG. 1A, and causes rotation around hinges 105 and 106 until that motion is stopped by contact of pressure plate 120 with door 101. Rotating board 110 is approximately perpendicular to the plane of door 101 as shown in FIG. 1A.

As door 101 is closed, wheel 136 comes into contact with pressure plate 120. As the door is closed and wheel 136 presses against pressure plate 120, rotating board 110 is rotated downwardly into the position shown in FIG. 2. In the position shown in FIG. 2, rotating board 110 is shown rotated about hinge 105 and hinge 106. That is, wheel 136 presses against pressure plate 120 and causes rotating board 110 to rotate into the plane of door 101, thereby pressing draft blocker 127 against any open space 134 (FIG. 3A) that may exist between the bottom of door 101 and threshold 124 of the doorway. In the position shown in FIG. 2, draft blocker 127 blocks drafts which would otherwise blow under door 101.

When door 101 is open as shown in FIG. 1A, pressure plate 120 contacts door 101 to limit the motion of rotating board 110 about hinge 105 and hinge 106, under the urging of spring 114.

Turning now to FIG. 3A, there is shown a cross-section A-A, as indicated in FIG. 2. Floor 132 supports threshold 124. Opening 134 between threshold 115 and door 101 permits an unwanted draft to pass under the door 101. Post 122 is shown with wheel 136 interacting with pressure plate 120, and that interaction forces rotating board 110 to rotate about hinges 105 and 106 into a position substantially within the plane of door 101, placing rotating board 110 substantially parallel to door 101. Draft blocker 127 moves into a position as illustrated in FIG. 3A to come into “draft blocking contact” with threshold 124, floor 132, and door 101.

In the absence of a threshold 124 under door 101 (not shown), draft blocker 127 would simply come into contact with floor 132 and door 101 to block any draft which would otherwise come under door 101.

In the draft blocking contact between draft blocker 127 and threshold 124, any draft which otherwise would pass through opening 134 is blocked.

As shown in FIG. 3A, draft blocker 127 is pressed with some force by support board 112 against the door and the floor, as shown by the dents 127D-1 and 127D-2 in FIG. 3A.

As door 101 is opened, moving from the position shown in FIG. 2 to the position shown in FIG. 1A, spring 114 applies a force to rotating board 110 that causes rotating board 110 to reassume the position substantially perpendicular to door 101, as shown in FIG. 1A. Pressure plate 120 moves into a plane substantially parallel to door 101, as rotating board 110 rotates up about hinge 105 and hinge 106 until pressure plate 120 comes into contact with door 101, thereby establishing the position shown in FIG. 1A.

As shown in section drawing FIG. 3A, post 122 has a wheel supported at its end. Wheel 136 presses against pressure plate 120 to reduce friction that a sliding contact would produce if there were no wheel 136. The radius of wheel 136 extends beyond the end of post 122 so that wheel 136 makes a rolling contact with pressure plate 120.

In an alternative exemplary embodiment of the invention (not shown), post 122 could be a solid post which presses against pressure plate 120. Post 122, by frictional force, then causes rotating board 110 to move from its position perpendicular to door 101 where it is urged by spring 114 as shown in FIG. 1A, to the position parallel to door 101 as shown in FIG. 2.

Turning now to FIG. 3B, an enlarged view of FIG. 3A is shown, and illustrates the interaction of post 122 which supports wheel 136, and pressure plate 120. When door 101 is moved into closed position as illustrated in FIG. 2 and FIG. 3A, wheel 136 applies force to pressure plate 120 to rotate rotating board 110 into a position substantially parallel to door 101.

### Second Exemplary Embodiment

### Draft Blocker with Movable Rotating Wheel

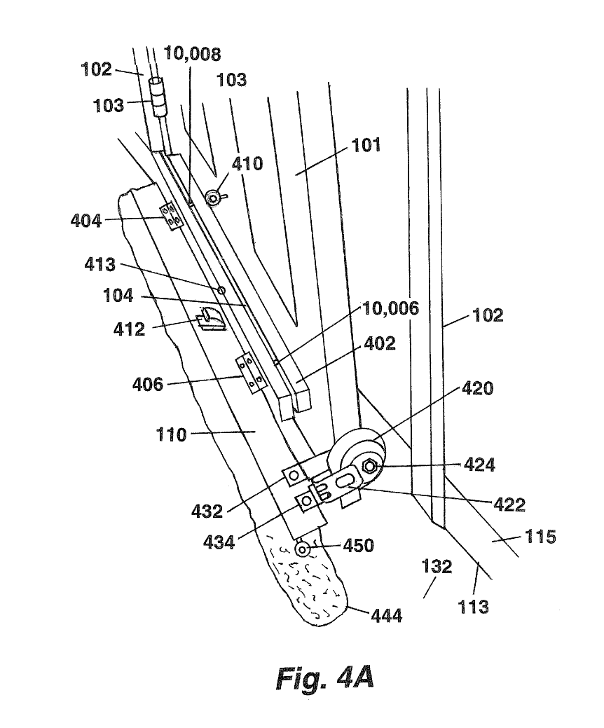

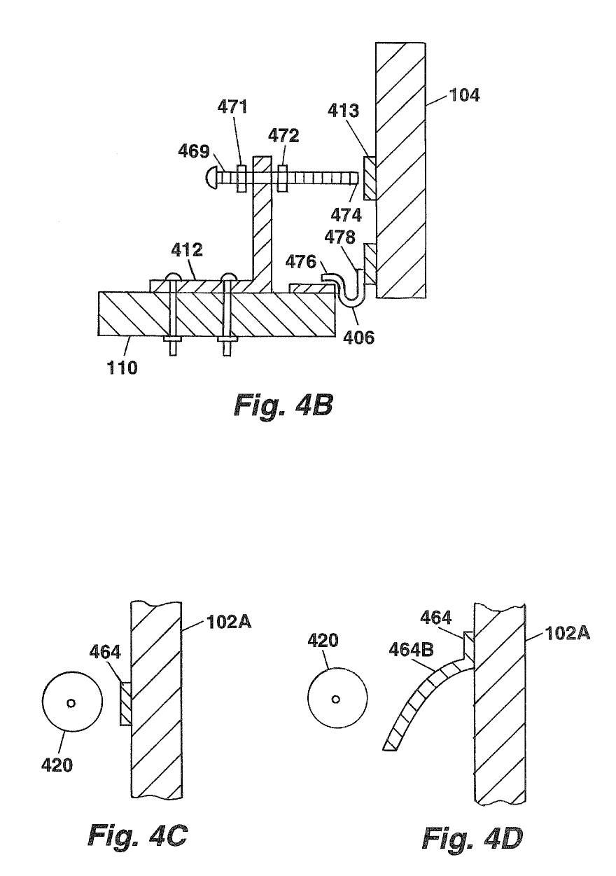

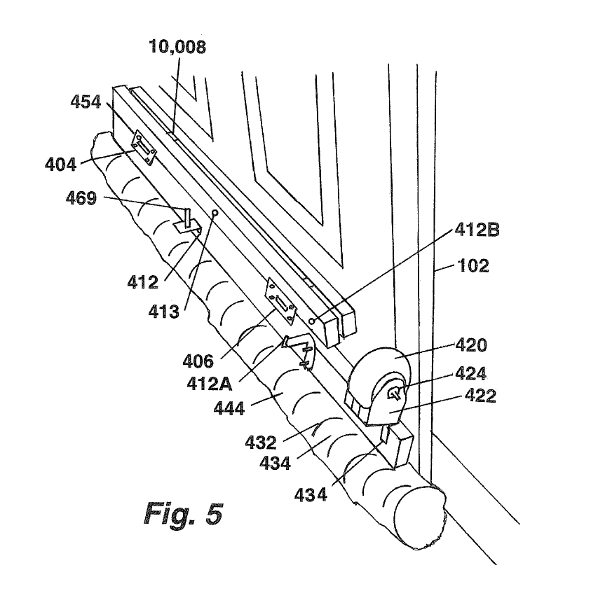

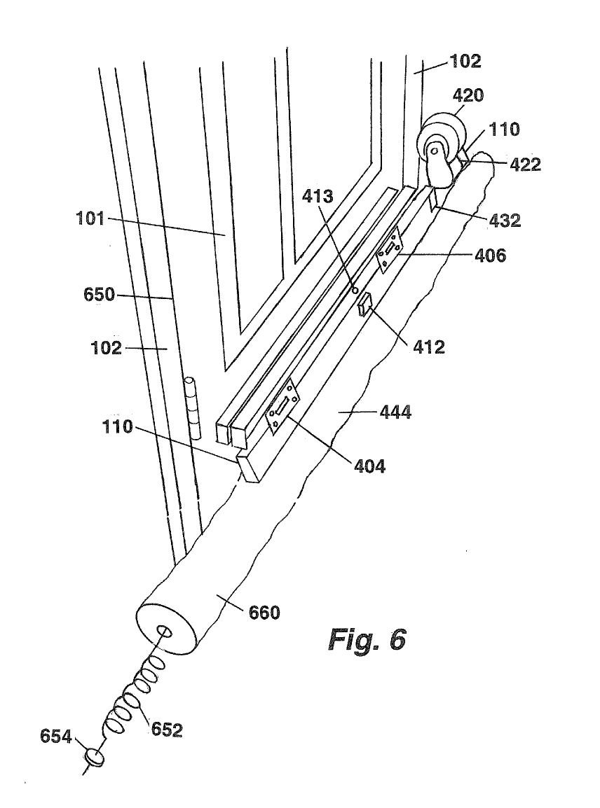

Turning now to FIG. 4A, FIG. 4B, FIG. 4C, FIG. 4D, and FIG. 5 and FIG. 6, a preferred embodiment of the invention is shown. Draft blocker 444 is placed into draft blocking position as door 101 is closed (FIG. 5), and draft blocker 444 is raised out of the way when door 101 is opened (FIG. 4A), as is more fully disclosed hereinbelow.

Door 101 is attached to the wall and door frame 102 by hinge 103, for rotation as the door opens and closes. Faceplate 402 is permanently attached to door 101. For example, faceplate 402 may be attached by wood screws to a wooden door.

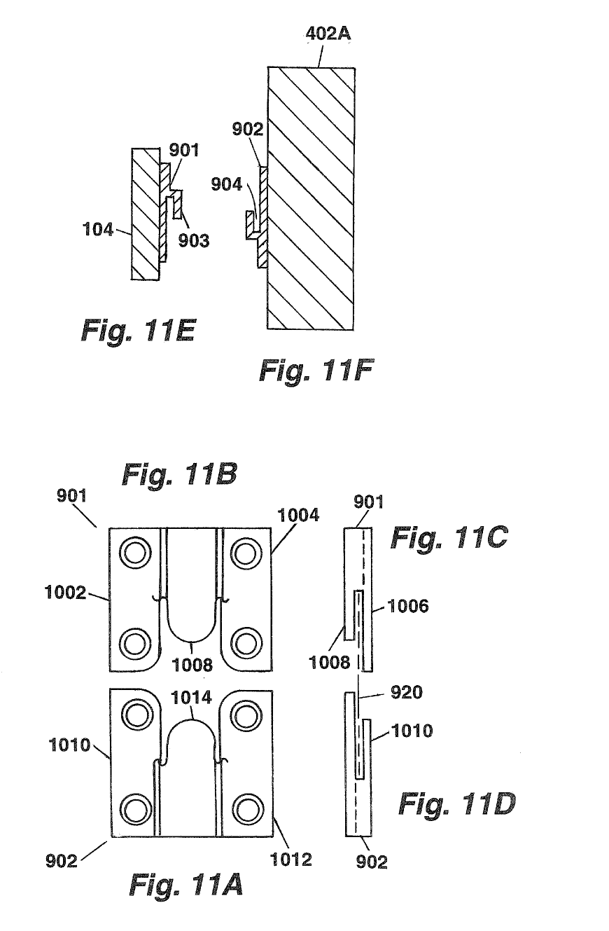

Alternatively, brackets such as those illustrated in FIG. 11A-FIG. 11F are used to removably attach mounting board 104 to faceplate 402, and thence to door 101, as will be further be described hereinbelow.

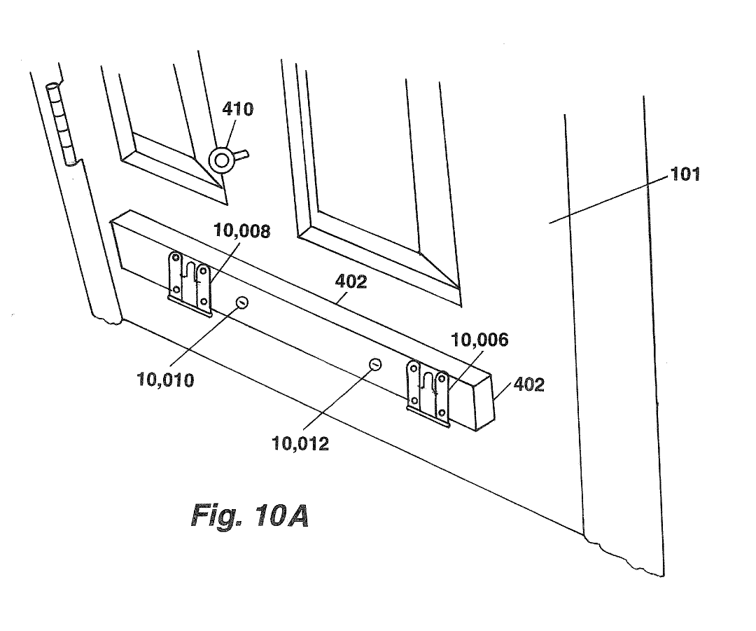

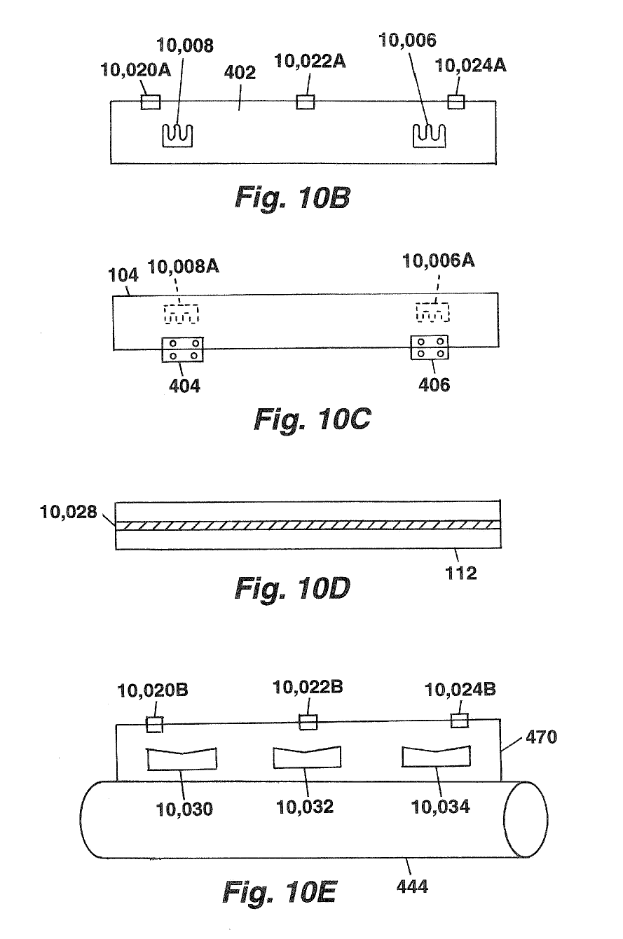

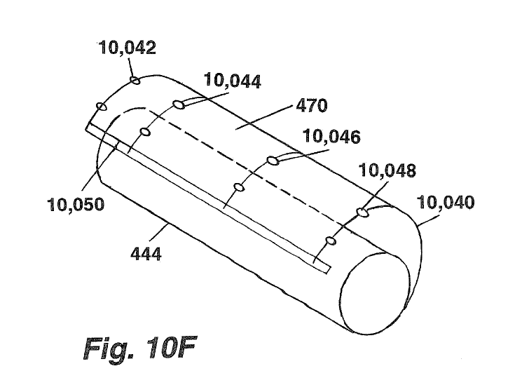

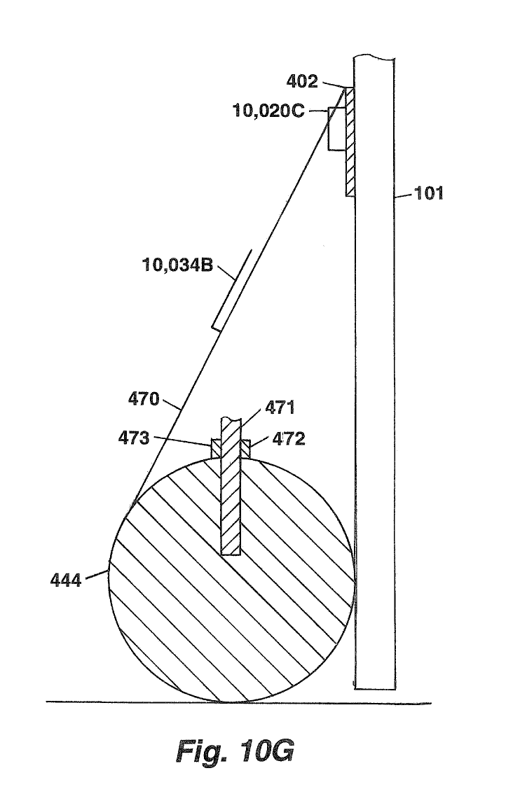

For example, faceplate 402 is illustrated in FIG. 10A. Turning now to FIG. 10A, faceplate 402 may be attached to door 101 by, for example, wood screw 10,010 and wood screw 10,012. Bracket 10,006 and bracket 10,008 are attached to faceplate 402, as illustrated in FIG. 10A. Alternatively, bracket 10,006 and bracket 10,008 may be attached directly to door 101, eliminating faceplate 402. Direct attachment of bracket 902 to door 101 is illustrated in FIG. 11F, where item 402A may be either faceplate 402 or door 101.

Bracket 10,006 and bracket 10,008 interlock with matching brackets attached to mounting board 104, as illustrated ion FIG. 11E and FIG. 11F by bracket 901 and bracket 902 for attachment of mounting board 104 to faceplate 402, or alternatively attaching mounting board 104 directly to door 101.

Returning now to FIG. 4A, mounting board 104 has brackets attached as illustrated in FIG. 11E and FIG. 11F. Bracket 901 attaches to mounting board 104 as shown in FIG. 11E. Bracket 902 may attach to door 101 or faceplate 402, as shown in FIG. 11E or FIG. 11F. Brackets such as bracket 901 attached to mounting board 104 mate with bracket 902 to attach mounting board 104 to door 101.

Alternatively, faceplate 402 is attached to door 101, and then bracket 902 mounts on faceplate 402, as shown by brackets 10,006 and 10,008 mounted on faceplate 402, as shown in FIG. 10A.

Faceplate 402 is mounted permanently, for example, by use of wood screws 10,010 and 10,012 to door 101, and mounting board 104 is removably attached to faceplate 402 by use of brackets 10,006 and 10,008, along with the matching brackets attached to mounting board 104.

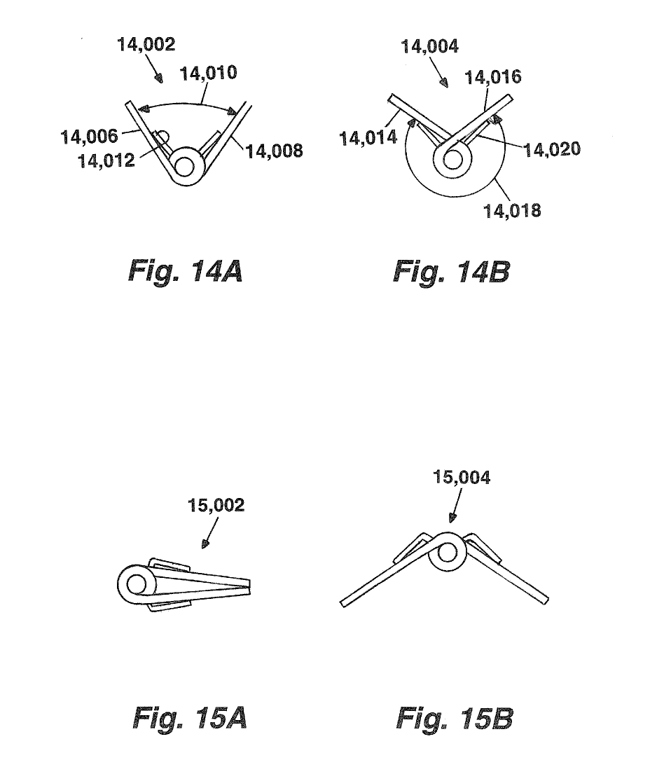

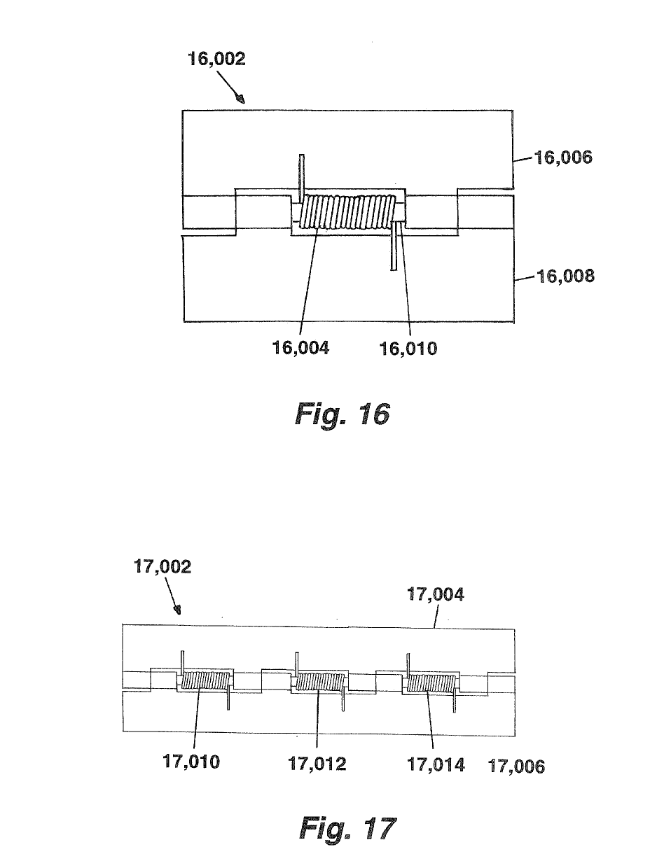

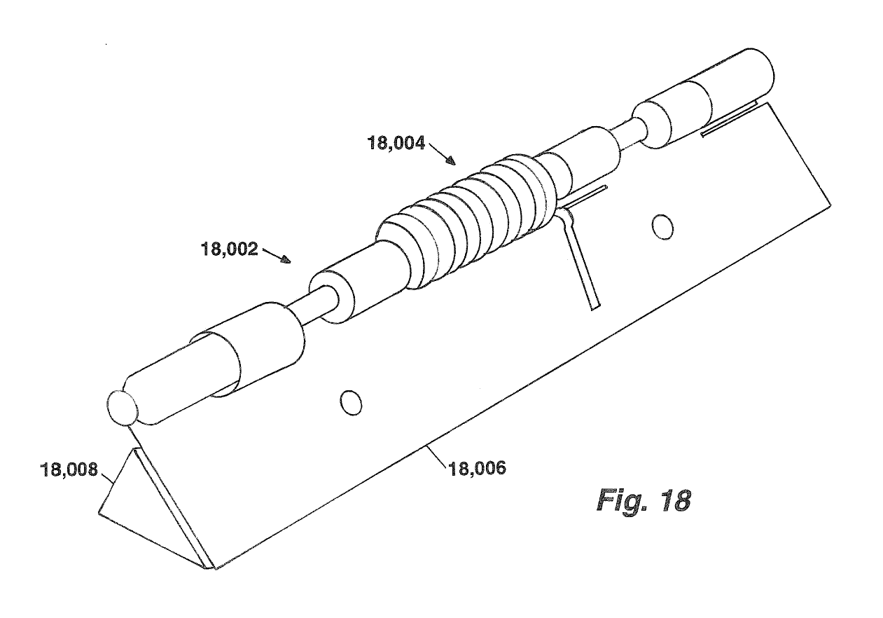

Returning to FIG. 4A, hinge 404 and hinge 406 are spring actuated hinges as illustrated in FIG. 14A, FIG. 14B, FIG. 15A, FIG. 15B, FIG. 16, FIG. 17 and FIG. 18. Spring actuated hinge 404 and spring actuated hinge 406 lift rotating board 110 into the position shown in FIG. 4A. Rotation of spring actuated hinge 404, 406 is limited by stop 412. For example, stop 412, as illustrated in FIG. 4A, and more particularly in FIG. 4B, may be an angle bracket (for example) permanently attached to rotating board 110, and arranged to contact mounting board 104 in order to prevent further rotation of spring actuated hinge 404 and spring actuated hinge 406 under the urging of springs in hinges 404, 406. Hinges with springs built therein are further illustrated if FIG. 14A-FIG. 18. Stop 412 is further illustrated in FIG. 5 and in FIG. 6.

Wheel 420 rotates on axle 424. Axle 424 is held by “U” bracket 422. U bracket 422 is fixedly attached to right angle bracket 432 and right angle bracket 434. The attachment of U bracket 422 to right angle bracket 432 and right angle bracket 434 is also illustrated in FIG. 7, and FIG. 8. Wheel 420 is referred to as a “movable rotating wheel” because it is attached to rotating board 110, and so “moves” as rotating board 110 rotates. In contrast, wheel 136 is mounted on post 122, and post 122 does not move, although wheel 136 rotates.

As door 101 is closed, wheel 420 comes into contact with door frame 102. Force between wheel 420 and door frame 102 applies a torque to hinge 406 and hinge 404, causing rotation about the hinges 404 and 406 in opposition to the force applied by the springs within the spring actuated hinges 404, 406. As the door is closed, wheel 420 reaches the position shown in FIG. 5, placing draft blocker 444 against the bottom of door 104 and against floor 132, thereby blocking any draft which would tend to pass between the bottom of door 101 and floor 132.

Eye hook 410 provides an upper attachment 116 to attach a helper spring such as is illustrated in FIG. 1 in the event that the springs within spring actuated hinges 404, 406 are not strong enough to lift rotating board 110 along with its attached wheel 420 and attached draft blocker 444.

Turning now to FIG. 4B, a cross-section illustrating stop 412 is shown. Stop 412 is fixedly attached to rotating board 110 by, for example, bolts 412A and 412B. Stop 412, is illustrated in FIG. 4B as an angle bracket which has a stopping mechanism as illustrated in FIG. 4B as a bolt with two nuts to prevent rotation of rotating board 412 into an angle too acute. Mounting board 104 is substantially fixedly attached to door 101 or to faceplate 402 shown in FIG. 10A. Springs 476 and 478 and hinge 406 cause rotating board 110 to rotate towards mounting board 104. Bolt 476 is adjusted by using nuts 471 and 472 to adjust the length of bolt 476 to pressure plate 413. The end of bolt 474 comes to rest against pressure plate 413 to maintain a desired angle, somewhat greater than 90°, between rotating board 110 and mounting board 104 when the springs 476, 478 lift rotating board 110 as the door is opened. Those skilled in the art will recognize that there are many alternative ways to implement a stop for rotating board 110

For example, stop 412 may be made of a right angle bracket comprising, steel for example, and bolt 470 may be held in position by nuts 471 and 472 to maintain a desired angle between rotating board 110 and mounting board 104 greater than 90°. This angle must be greater than, for example, 90° in order that wheel 420 applies torque to the rotating board 110 that causes draft blocker 444 to rotate downwardly. This adjustment of stop 412 and bolt 470 can cause wheel 420 to assert torque in a direction causing rotating board 110 to approach mounting board 104 if the angle between rotating board 110 and mounting board 104 is less than 90°. Accordingly, it is important to assure that stop 412 is properly adjusted to ensure that the proper sign of the torque applied by wheel 420 is, in fact, applied.

Shield 413 is used to prevent bolt 476 from damaging mounting board 104 under the influence of spring 476 and 478. For example, shield 413 may be a flat piece of steel attached fixedly to mounting board 104, for example by glue, bolts or threaded screws.

Turning now to FIG. 4C, a schematic illustration of the interaction of wheel 420, shown in FIG. 4A and 5, with door frame 402 is shown in cross-sectional drawing FIG. 4C. Wheel 420 contacts shield 464 in order to provide a pressure surface for wheel 420 to operate against door frame 102. Shield 464 protects door frame 102. Wheel 420 comes into contact with shield 464. Also, shield 464 provides a smooth surface to assist smooth rotation of wheel 420 as the door 101 is closed.

Turning now to FIG. 4D, an alternate arrangement of shield 464 is shown. As shown in FIG. 4D, shield 464 is a leaf spring attached at its base 464 to portion 102A of door frame 102. Shield 464 has a springy portion 464B which is contacted by wheel 420 as door 101 is closed. Springy portion 464B of shield 464 provides a resilient contact surface for wheel 420. By use of springy portion 464B, the necessity of precise adjustment of the location of wheel 420 relative to the door frame portion 102A is relieved. Springy portion 464B of shield 464 provides a smooth resilient spring-action for wheel 420 as door 101 is closed.

Turning now to FIG. 6, a view from the left of the apparatus is shown where it is illustrated that draft blocker 444 extends beyond the hinge line 650 of door 101. An auxiliary spring 652 is shown attached to eye hook 654 at one end and at the other end 652 is attached to draft blocker 444 in order to assist draft blocker 444 in moving to the desired position when door 101 is closed.

As illustrated in FIG. 7, draft blocker 444 is urged into position for a tight fit between both door 101 and floor 132 by being attached to rotating board 110 by the use of attachment hooks 450, 451, 454. By placing attachment hooks 450, 451 and 454 on the side 460 of rotating board 110 that faces door 101, the rotating board 110 gently urges the soft material of draft blocker 444 against both the door 101 and the floor 132 as illustrated in FIG. 2 and FIG. 3A in order to assist in blocking any draft which might tend to come under door 101 when door 101 is in the closed position.

Turning now to FIG. 8, there is illustrated the attachment of wheel 420 to the rotating board 110 by right angle bracket 432 and right angle bracket 434 which are attached to both rotating board 110 and U bracket 422. For example, as shown in the illustrative example FIG. 8, U bracket 422 is attached to both right angle bracket 432 and right angle bracket 434 by bolts, 432A and 434A, respectively. Also, for example, right angle bracket 432 is shown attached by bolts 432B to rotating board 110, as is also right angle bracket 434 attached to rotating board 110 by the use of bolts 434B.

Turning now to FIG. 9, there is illustrated a rear view of mounting board 104 and rotating board 110, along with the attachment of draft blocker 444 using hooks 450, 451 and 454.

Bracket 10,006A mates with bracket 10,006 as illustrated in FIG. 9 and FIG. 10A, and bracket 10,008A mates with bracket 10,008 also illustrated in FIG. 9 and FIG. 10A. Bracket 10,006A with mating bracket 10,006, and bracket 10,008A with mating bracket 10,008 forms a removable attachment of mounting board 104 to faceplate 402. Faceplate 402 is permanently attached to door 101. Accordingly, brackets 10,006, 10,008 and brackets 10,006A, 10,008A mate together to form a removable attachment of mounting board 104 to door 101.

Turning now to FIG. 10A, faceplate 402 is shown attached to door 101, for example, by wood screw 10,010 and wood screw 10,012. Faceplate 402 is used to attach, in a removable fashion, mounting board 104 to door 101, as described hereinabove.

Turning now to FIG. 10B, 10C, 10D, and 10E, there is illustrated an assembly diagram of the mechanism to rotate draft blocker 444 into draft blocking position as the door is closed. In FIG. 10B, faceplate 402 is illustrated with bracket 10,008 and bracket 10,006. Bracket 10,008 and bracket 10,006 are illustrated in FIG. 10A, and also are illustrated in FIG. 10B. Attachment 10,020A, attachment 10,022A, and attachment 10,024A support a flexible shield 470 as illustrated in FIG. 10E, FIG. 10F, and FIG. 10G, as will be more thoroughly discussed herein below. In FIG. 10C mounting board 104 is illustrated with bracket 10,006A in dotted line as being on the reverse side of FIG. 10C, as also is bracket 10,006A. Bracket 10,008A couples with bracket 10,008, as illustrated in more detail with reference to FIG. 11E and FIG. 11F. Bracket 10,006A is also on the reverse side of FIG. 10C, as illustrated by it being in dotted lines in FIG. 10C, and couples with bracket 10,006 as is also further illustrated in FIG. 11E and FIG. 11F. Brackets 10,008 and 10,008A coupling together and bracket 10,006 coupling with bracket 10,006A provide a removable attachment of mounting board 104 to faceplate 402. Attachment is also illustrated in FIG. 4A as mounting board 104 was attached to faceplate 402.

Turning now to FIG. 10C, hinge 405 and hinge 406 provide a hinge attachment of support board 112, as shown in FIG. 10D. Hinge 405 and hinge 406 attach to support board 112 as illustrated in FIG. 10D.

Also illustrated in FIG. 10D is an alternative attachment method for attaching draft blocker 444 to support board 112, through zipper 10,028. Zipper 10,028 is a first side of a zipper. The other side of the zipper (not illustrated) is built into draft blocker 444. With zipper 10,028 and its matching half, draft blocker 444 may be zip-attached to support board 112.

Turning now to FIG. 10E, shield 470 is attached to draft blocker 444. Attachment devices 10,020B, 10,022B and 10,024B attach to attachment devices 10,020A, 10,022A and 10,024A, respectively, to attach shield 470 to faceplate 402. Shield 470 provides several functions, including blocking drafts which would otherwise pass beside draft blocker 444, providing a decorative shield of the draft blocker lifting mechanism from people in the room having floor 132, and provides pockets 10,030, 10,032 and 10,034. Pockets 10,030, 10,032 and 10,034 may be used to hold aromatic material such as spices, aromatic leaves and other pleasing materials for providing a fresh odor in the room when the door 101 is closed.

Turning now to FIG. 10F, draft blocker 444 is illustrated having a flexible shield 10,040, also as illustrated as flexible shield 470. Strip 10,050 contains attachment devices 10,020B, 10,022B and 10,024B which attach the shield 470 to attachment devices 10,020A, 10,022A and 10,024A, respectively. Decorative buttons 10,042, 10,044, and 10,046 and 10,048 provide a pleasing appearance in the room when door 101 is closed.

Turning now to FIG. 10G, door 101 is illustrated schematically in an end view/cross section along with draft blocker 444 and shield 470. Lifting board 471 is illustrated attached to draft blocker 444 using strips 472 and 473. Mounting board 402 is illustrated with attachment device 10,020C, where attachment device 10,020C stands for a side view of attachment devices 10,020A, 10,022A, 10,024A and attachment devices 10,020B, 10,022B, and 10,024B. Pockets 10,030, 10,032, and 10,034 are illustrated in side view by pocket 10,034B. The remainder of the operating mechanism for lifting the draft blocker 444 is not illustrated in FIG. 10G.

### Third Exemplary Embodiment

### Bracket for Removable Mounting

Turning now to FIG. 11E and FIG. 11F, there is shown a two part bracket 901 and 902 holding a mounting board 104 to a board 402A. Board 402A may be, for example, door 101 (FIG. 1) or may be faceplate 402. Bracket 901 is fastened to mounting board 104 in a fixed fashion. For example, Bracket 901 may be held to mounting board 104 by screws, bolts, rivets, or other fixed type fastening device.

Similarly, bracket 902 is fastened to board 402A in fixed fashion. Again, for example, bracket 902 is fastened to board 402A by screws, bolts, rivets, or by other suitable fastening means.

In use, tongue 903 of bracket 901 fits into slot 904 of bracket 902, as is further illustrated in FIG. 11A, FIG. 11B, FIG. 11C, and FIG. 11D. The two brackets 901 and 902 interlock to fasten mounting board 104 to faceplate 402 in a removable fashion.

Bracket 902 may be attached directly to door 101 in order to attach mounting board 104 to door 101, or bracket 902 may be attached to faceplate 402.

Alternatively, it may be convenient to use additional removable fasteners to anchor mounting board 104 to faceplate 402 or to door 101 to prevent mounting board 104 from becoming dislodged from door 101 during use.

Turning now to FIG. 11A, FIG. 11B, FIG. 11C, and FIG. 11D, there is illustrated an exemplary embodiment of brackets 901, 902. Bracket 901 has mounting plates 1002 and 1004. The side view FIG. 11C shows mounting plate 1006, and mounting plate 1006 is a side view of a near edge of mounting plate 1004. Mounting plates 1002 and 1004 are fixedly attached to mounting board 104 by screws, bolts, rivets, or other convenient fastening means. Tongue 1008 rises out of a plane of mounting plates 1006.

Similarly, bracket 902 has a fixed attachment to faceplate 402 or to door 101 by mounting plate 1010 and 1012, and is held in place by screws, bolts, rivets, or other convenient fastening means.

Tongue 1014 of bracket 1010 interlocks with tongue 1008 of bracket 1002 in order to make a removable attachment of mounting board 104 faceplate 402 or to door 101. In use of the invention, it is convenient to remove the apparatus from door 101 when the weather does not cause undesirable draft and wind from passing under door 101. Accordingly, it is convenient to employ brackets 901 and 902 to make a removable attachment of the inventive apparatus to faceplate 402 or to door 101.

### Fourth Exemplary Embodiment

### One Size Fits All

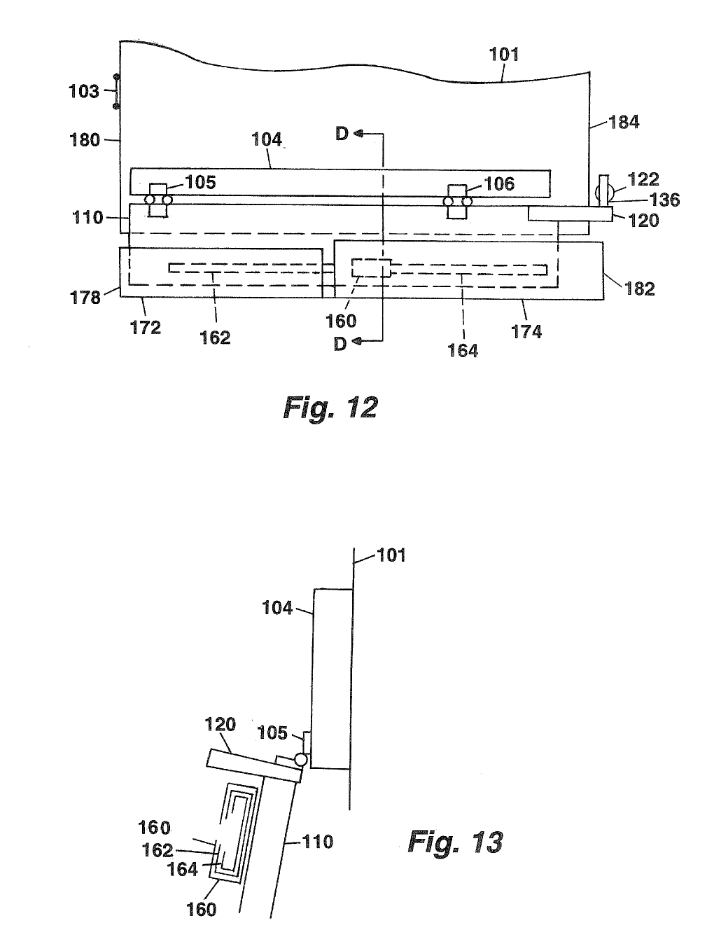

Turning now to FIG. 12 and FIG. 13, an alternative embodiment of the invention is shown. Door 101 is shown supporting mounting board 104 at the inside side of door 101. Mounting board 104 has hinges 105 and 106 attaching rotating board 110 in a rotatable status. Pressure plate 120 is shown in FIG. 12.

Clamp 160 is fixably attached to rotating board 110. Movable shield 172 is fixably attached to bracket 162. Bracket 162 is slidably engaged with bracket 160. Movable shield 174 is fixably attached to bracket 164. Bracket 164 is slidably engaged with bracket 160 and bracket 162.

Movable shield 172 and movable shield 174 provide a “one size fits all” embodiment of the present invention, so that a single commercial kit may be adjusted to fit a door of any width.

Movable shield 172 may be moved into position on an arbitrarily wide door 101 so that it comes into position 178, where it is even with hinged side 180 of door 101. Movable shield 174 may be adjusted by sliding bracket 164 within bracket 162 in order to adjust the right hand side 182 of movable shield 174 to cover the right hand edge 184 of door 101.

By setting movable shield 172 and movable shield 174 into the appropriate positions, the invention may be made to accommodate a range of widths of door 101. In setting movable shield 172 and movable shield 174 into position, for example, set screws (not shown), or other appropriate fastening means, may be used to make the positions in which brackets 160, 162 and 164 are set into a “permanent” setting to accommodate the width of door 101.

### Fifth Exemplary Embodiment

### Spring Actuated Hinge

Turning now to FIG. 14A and FIG. 14B, there is shown a hinge which is biased open by a spring internal to the hinge. The hinges of FIGS. 14A, 14B, 15A, 15B, 16, 17 and 18 are referred to as “spring actuated hinges.” In FIG. 14A hinge 14,002 is biased open, with the open position having side 14,006 and side 14,008 open with an approximately right angle 14,010 between sides 14,006 and 14,008. The hinge 14,002 is closed by applying force against sides 14,006, 14,008 to reduce angle 14,010 against resistance offered by spring 14,012.

In FIG. 14B hinge 14,004 is biased open with sides 14,014 and 14,016 with closing angle 14,018 somewhat larger than 180 degrees. Hinge 14,004 is closed by applying force to sides 14,014 and 14,016 to reduce closing angle 14,018, thereby bringing side 14,014 closer to side 14,016. Side 14,014 can be brought substantially into contact with side 14,016 by applying sufficient force against the sides 14,014, 14,016 and against resistance offered by spring 14,020 to reduce closing angle 14,018 to substantially zero degrees.

A hinge 14,002 with an internal spring 14,012 such as is shown in FIG. 14A can be substituted for hinge 105 and hinge 106 as shown in FIG. 1 and FIG. 2, etc. to replace the function of spring 114 by spring 14,012 or spring 14,020.

Further, a hinge 14,004 as shown in FIG. 14B can also be used instead of hinge 105 and hinge 106 as shown in FIG. 1 and FIG. 2, etc., and can also be used in place of hinge 11,020A and hinge 11,020B as shown in FIG. 11-FIG. 12.

Turning now to FIG. 15A and FIG. 15B, there is shown a hinge 15,002 and hinge 15,004, and both hinges 15,002, 15,004 are shown in the closed position, with an internal spring biasing the hinge closed. Either hinge 15,002 or hinge 15,004 may be used to replace hinge 105 and hinge 106, with the internal spring performing the function of spring 114.

Turning now to FIG. 16, a top view of a hinge 16,002 which is biased open or closed by spring 16,004 is shown. Plate 16,006 and plate 16,008 may be rotated about shaft 16,010 by a force applied between them, where the force overcomes resistance produced by spring 16,004 as the plates 16,006, 16,008 are rotated about shaft 16,010.

Also, a hinge 16,002 with an internal spring 16,004 can be used to replace hinges 105, 106, (FIG. 1) with the spring 16,004 performing the function of spring 114.

Turning now to FIG. 17, there is shown a hinge 17,002. Hinge 17,002 has plate 17,004 and plate 17,006. Plate 17,004 and plate 17,006 are biased by three springs, spring 17,010, spring 17,014, and spring 17,014.

A hinge 17,002 with a plurality of internal springs such as springs 17,012, 17,014, 17,016 can be used to replace hinges 105, 106. Then springs 17,012, 17,014, 17, 016 perform the function of spring 114.

Whether a hinge biased by one spring, or a hinge biased by a plurality of springs is chosen to operate the present invention depends on design choices such as the weight of the moving parts, the strength of the springs, the amount of force to be applied to the rotating board, the balance provided by the hinge parts and springs and weight to be lifted by the rotating board, etc.

Turning now to FIG. 18, there is shown an isometric drawing of a hinge 18,002 biased by spring 18,004. For example, hinge 18,002 may be attached to mounting board 104 (FIG. 1) by plate 18,006, and may be attached to rotating board 110 by plate 18,008. When the door 101 is in the open position, spring 18,004 holds rotating board 110 in a plane substantially perpendicular to the vertical plane of door 101.

As the door 101 is closed, force is applied by post 122 and wheel 136 to pressure plate 120 to overcome the resistance offered by spring 18,004, and rotating board 110 rotates downward into the door closed position shown in FIG. 2 and FIG. 3, with rotating board 110 in a plane substantially parallel to the plane of door 101.

### Sixth Exemplary Embodiment

### Draft Protector with Draft Blocker

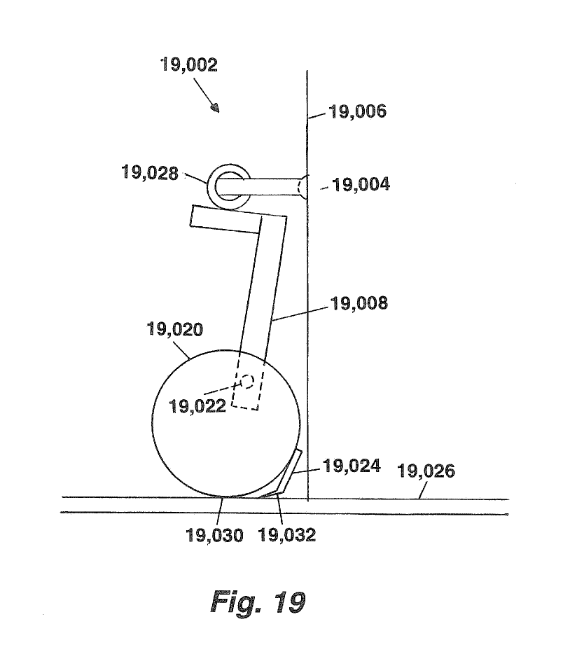

Turning now to FIG. 19, there is shown an inventive draft protector 19,002. Rotating mechanism 19,004 is shown attached to door frame 19,006. Rotating board 19,008 is attached by a hinge (not shown in FIG. 19) to the door (not shown in FIG. 19).

Draft blocker 19,020 is attached by a shaft 19,022 which is shown as a hidden circular line. A portion of rotating board 19,008 is also shown as a hidden line, as draft protector 19,020 may protrude in a direction perpendicular to the plane of side view FIG. 19 beyond rotating board 19,008. Shaft 19,022 is supported by rotating board 19,008.

As the door (not shown in FIG. 19) is closed, rotating mechanism 19,004 moves rotating board 19,008 into the position shown in FIG. 19. Rotating mechanism 19,004 is shown as a roller 19,028 attached to door frame 19,006. However rotating mechanism 19,004 could be any convenient rotating mechanism such as a wheel as shown in FIG. 4 through FIG. 10, etc. Rotating mechanism 19,004 is referred to as a “fixed rotating wheel” because it is attached to door frame 19,006. In the position shown in FIG. 19, sweep 19,024 is brought into contact with floor 19,026.

Draft blocker 19,020 may be made of any soft, pliable material which aids in blocking an unwanted draft which otherwise would pass under the door by making a seal along line of contact 19,030 with floor 19,026. For example, a suitable pliable material for making draft protector 19,020 could be, for example, cloth, a cloth cylinder, a soft plastic material, etc. Also, sweep 19,024 may be made of a pliable material such as, for example, rubber, plastic, synthetic rubber, etc. Further, sweep 19,024 may be attached to draft blocker 19,020 as shown in FIG. 19 in order to provide two sealing joints with the floor 19,026, one at line of contact 19,030 and another at line of contact 19,032 in order to aid in blocking an unwanted draft which would tend to come under the door. Alternatively, sweep 19,024 may be supported directly by shaft 19,022 (not shown) in order to facilitate blocking an unwanted draft from coming under the door. Sweep 19,024 may be omitted in the event that contact between draft blocker 19,020 and the floor 19,026 along contact line 19,030 is sufficient to block any anticipated draft, and also if draft blocker 19,020 makes a firm contact with the door.

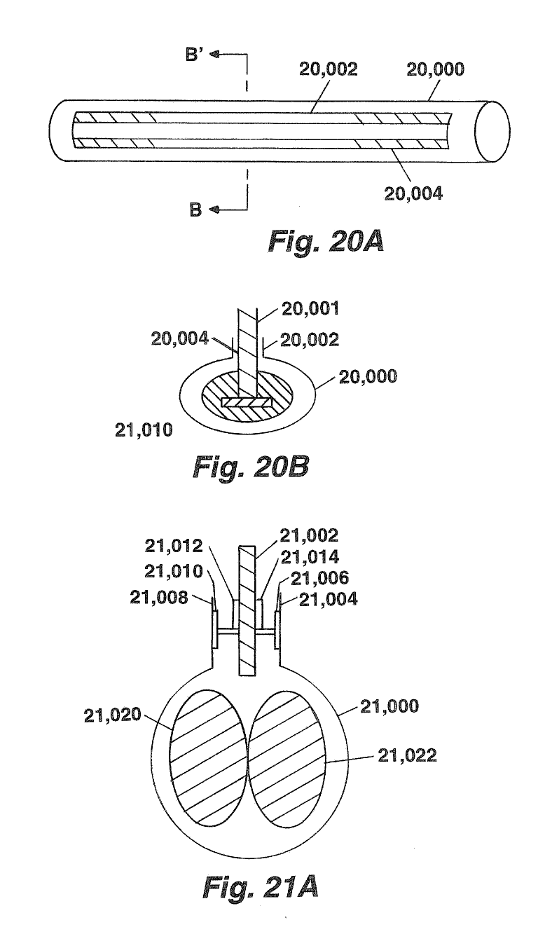

Turning now to FIG. 20A, draft blocker 20,000 is shown. Draft blocker 20,000 has side 20,002 and side 20,004 on opposite sides of slot 2006. As illustrated in FIG. 20B, which is a cross-section of FIG. 20A at section B-B′, side 20,002 and side 20,004 attach to support board 20,001. For example, side 20,002 and side 20,004 may have Velcro attached thereto, and matching Velcro attached to either side of support board 20,001. Additional support from support board 20,001 is provided to draft blocker 20,000 by plate 20,010. Plate 20,010 provides support for draft blocker 20,000 so that force applied to draft blocker 20,000 can provide the force required to make the dents shown in FIG. 3A, as dent 127-D1 and dent 127-D2.

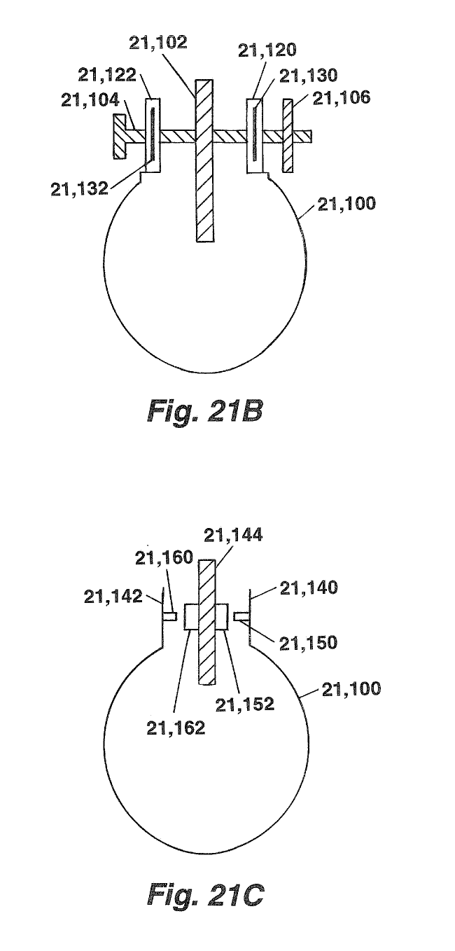

Turning now to FIG. 21A, an alternative support mechanism for draft blocker 21,000 is shown. Support board 21,002 is illustrated as having one side of a zipper 20,014 attached to support board 21,002. A matching half of zipper 21,014 is illustrated as item 21,006 and item 21,006 is attached fixedly to flap 21,004 of draft blocker 21,000.

Also, flap 21,008 of draft blocker 21,000 has attached thereto one half of a zipper 21,010. A matching half of zipper 21,010 is attached as item 21,012 to support board 21,002. Insulating material 21,020 and 21,022 is shown inside of draft blocker 21,000. Alternatively, support plate 21,010, as illustrated in FIG. 20B, could be used in FIG. 21A to supply additional support for draft blocker 21,000 (not shown in FIG. 21A).

Support board 20,001 and support board 21,002 provide support to press draft blocker 20,080 or draft blocker 21,000, respectively, into the position with force as shown in FIG. 3A, where the force helps develop dent 127-D1 and dent 127-D2.

Alternative methods of attaching a draft blocker to a support board are illustrates in FIG. 21B and FIG. 21C. For example, draft blocker 21,100 may be attached by a bolt 21,104 to support board 21,102 as illustrated in FIG. 21B. Alternatively, a snap connector for attaching draft blocker 21,100 to support board 21,144 is illustrated in FIG. 21C.

Turning now to FIG. 21B, draft blocker 21,100 is supported by support board 21,102. Pocket 21,120 is formed into draft blocker 21,100 as is also pocket 21,122. A strip of resilient material 21,130 is encased in pocket 21,120. Resilient material 21,130 may be, for example, an aluminum strip, another metal strip, a strip of plastic, etc. Also, strip 21,132 is enclosed in pocket 21,122. Strip 21,132 may, for example, be made of the same material as strip 21,130.

Bolt 21,104 fastens draft blocker 21,100 to support board 21,102 by means of bolt 21,104 which passes through a hole (not shown) through pocket 21,122, through to the strip 21,132, support board 21,102, pocket 21,120, and strip 21,130. Bolt 21,132 is held in place by tightening nut 21,106 to make a tight assembly to securely fasten draft blocker 21,100 to support board 21,102.

The contents of draft blocker 21,100 are not shown in FIG. 21B.

Turning now to FIG. 21C, draft blocker 21,100 is shown attached to support board 21,144. Side 21,140 and side 21,142 are made into draft blocker 21,100.

Snap fastener 21,150 is attached to side 21,140 of draft blocker 21,100. Snap connector 21,150 is inserted into receptacle 21,152 to create a snap attachment of draft blocker 21,100 to support board 21,144.

Also, snap connector 21,160 is attached to side 21,142 of draft blocker 21,100. Snap connector 21,142 is inserted into snap receptacle 21,162 in order to fasten draft blocker 21,100 to support board 21,144.

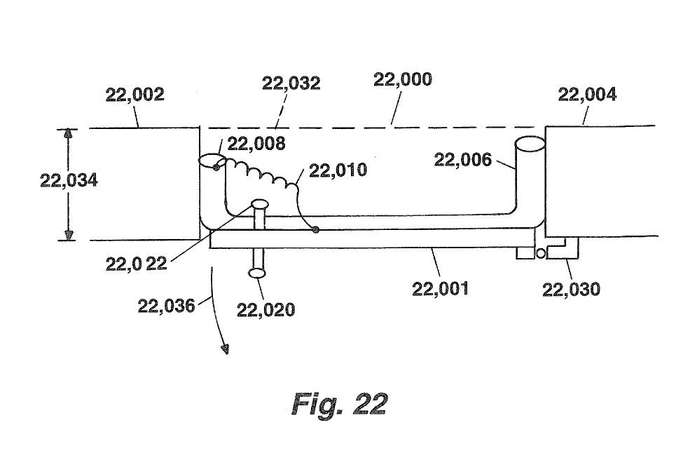

Turning now to FIG. 22, a top view of a door mounted in an alcove 22,000, and employing the present draft blocker lifting mechanism is shown. Door 22,001 is attached by hinge 22,030 to wall 22,004. Wall 22,004 matches wall 22,002, as shown by dotted line 22,032. Distance 22,034 is substantial and forms an alcove for door 22,001.

Draft blocker 22,006 is illustrated as fitting into the alcove formed by distance 22,034. The lifting mechanism for draft blocker 22,006 described hereinbefore operates to raise draft blocker 22,006 when door 22,001 is open in the direction illustrated by arrow 22,036. Spring 22,010 applies force to end 22,008 of draft blocker 22,006 as door 22,001 is opened, in order to lift end 22,008 as draft blocker 22,006 is lifted by the mechanism described hereinbefore.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A draft blocking apparatus for a door, comprising:
a hinge for attachment to a door;
a rotating assembly attached to the door so as to permit the rotating assembly to rotate about the hinges, and to rotate relative to the door, the rotating assembly arranged to accommodate a draft blocker; and
a mechanism to convert motion of the door as the door is closed into motion to lower the draft blocker into a position to contact a floor by rotation about the hinges, in order to block a draft which would otherwise pass under the door when the door is in a closed position.

2. The apparatus as in claim 1, further comprising:
a mounting board to support the hinges, the mounting board attached to the door.

3. The apparatus as in claim 1 further comprising:
a support board hingeably attached to the rotating board to provide support for the draft blocker.

4. The apparatus as in claim 1 further comprising:
a wheel mounted to a post to interact with a pressure plate to provide an interaction with the rotating assembly to move he draft blocker into draft blocking position as the door is closed.

5. The apparatus as in claim 1 further comprising:
a wheel mounted on the rotating assembly so that as the door is closed the wheel comes into contact with a part of a door frame, and as the door is closed the wheel causes the rotating assembly to rotate and thereby place the draft blocker into a draft blocking position.

6. The apparatus as in claim 1 further comprising:
a first bracket attached to the rotating board;
a second bracket attached to a first movable shield;
a second bracket attached to a second movable shield;
the movable shields capable of being adjusted to cover an open space at a bottom of a door of arbitrary width.

7. The apparatus as in claim 1, further comprising:
a pressure plate to cause the rotating board to rotate from a first position maintained while the door is open into a draft blocking position when the door is closed.
